(19) United States
(12) Patent Application Publication
(10) Pub. No.: US 2015/0277197 A1
(43) Pub. Date: Oct. 1, 2015

(54) ARRAY SUBSTRATE, METHOD FOR REPAIRING THE SAME AND DISPLAY APPARATUS

(71) Applicants: BOE TECHNOLOGY GROUP CO., LTD., Beijing (CN); BEIJING BOE DISPLAY TECHNOLOGY CO., LTD., Beijing (CN)

(72) Inventors: Xi Chen, Beijing (CN); Guoqi Mao, Beijing (CN); Liangliang Li, Beijing (CN); Yao Liu, Beijing (CN)

(21) Appl. No.: 14/316,039

(22) Filed: Jun. 26, 2014

(30) Foreign Application Priority Data
Mar. 28, 2014 (CN) 201410122924.9

(51) Int. Cl. G02F 1/1362; G02F 1/1368

(52) U.S. Cl. CPC G02F 1/136259; G02F 1/136286; G02F 1/1368

(57) ABSTRACT

An array substrate, a method for repairing the same and a display apparatus are disclosed. The array substrate, comprises: a plurality of first signal lines and a plurality of second signal lines; a plurality of pixel units each comprising a thin film transistor and a pixel electrode; and connecting assemblies comprising a plurality of first portions arranged in the layer in which the second signal lines are located and a plurality of second portions arranged in the layer in which the pixel electrodes are located, the first signal lines, the second signal lines and the pixel electrodes being in different layers on the array substrate respectively, the first portions and the second portions in the connecting assemblies being arranged alternatively, the plurality of first portions being partly overlapped with the first signal lines respectively, the second portions being partly overlapped with adjacent first portions.

### CROSS-REFERENCE TO RELATED APPLICATION

This application claims the benefit of Chinese Patent Application No. 201410122924.9 filed on Mar. 28, 2014 in the State Intellectual Property Office of China, the whole disclosure of which is incorporated herein by reference.

### BACKGROUND OF THE INVENTION

1. Field of the Invention

The present disclosure relates to a technical field of display, more particularly, to an array substrate, a method for repairing the same and a display apparatus.

2. Description of the Related Art

TFT-LCD(thin film transistor liquid crystal display) has become popular more and more due to its advantages of such as small volume, low power consumption and no radiation. In the field of flat panel display, TFT-LCD is dominant and has been used widely in all of industries. In the practical manufacturing of the TFT-LCD, disconnections of gate lines or data lines are inevitable. A typical repairing process is performed by depositing metal at the disconnected locations. However, such process needs an additional depositing process, which may prolong the producing period, even may degrade the aperture ratio of the display apparatus and reduce the visual effects of users.

### SUMMARY OF THE INVENTION

An object of an embodiment of the present invention is to provide an array substrate, a method for repairing the same and a display apparatus that can allow the disconnected lines to be repaired by a simple and efficient method and can ensure the success chance of repairing, and thus reduce the producing period and improve the yield of products.

In order to solve the above technical problem, the present disclosure may be implemented by the following technical solutions:

According to an aspect of the present disclosure, there is provided an array substrate, comprising:

a plurality of first signal lines and a plurality of second signal lines formed on the array substrate, the plurality of first signal lines and the plurality of second signal lines being crossed to each other;

a plurality of pixel units, each of which is located in one of areas surrounded by the first signal lines and the second signal lines and comprises a thin film transistor and a pixel electrode; and

connecting assemblies arranged in parallel to the first signal lines,

wherein the connecting assemblies comprise a plurality of first portions arranged in the layer in which the second signal lines are located and a plurality of second portions arranged in the layer in which the pixel electrodes are located, the first signal lines, the second signal lines and the pixel electrodes being in different layers on the array substrate respectively, the first portions and the second portions in the connecting assemblies being arranged alternatively in a direction in which the first signal lines extend, the plurality of first portions being partly overlapped with the first signal lines respectively, the second portions being partly overlapped with adjacent first portions.

According to another aspect of the present disclosure, there is provided a display device, comprising the array substrate as described above.

According to another aspect of the present disclosure, there is provided a method for repairing the above array substrate, comprising:

if one of the first signal lines is disconnected, connecting the first portions of the connecting assemblies on both sides of the disconnected location of the one of the first signal lines to the parts of the first signal lines overlapped with the first portions respectively, and connecting the first portions of the connecting assemblies connected to the one of the first signal line to the parts of the second portion of the connecting assemblies overlapped with the first portions respectively.

### BRIEF DESCRIPTION OF THE DRAWINGS

The above and other features of the present invention will become more apparent by describing in detail exemplary embodiments thereof with reference to the accompanying drawings, in which:

FIG. 1 is a first schematic view showing a structure of a substrate in accordance with an embodiment of the present invention;

FIG. 2 is a second schematic view showing a structure of a substrate in accordance with an embodiment of the present invention;

FIG. 3 is a schematic view showing a section taken along line A-A shown in FIG. 2 in accordance with an embodiment of the present invention;

FIG. 4 is a third schematic view showing a structure of a substrate in accordance with an embodiment of the present invention; and

FIG. 5 is a schematic view showing a section taken along line B-B shown in FIG. 4 in accordance with an embodiment of the present invention.

### DETAILED DESCRIPTION OF EMBODIMENTS OF THE INVENTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In accordance with a general invention concept of the present disclosure, an array substrate is provided, comprising: a plurality of first signal lines and a plurality of second signal lines formed on the array substrate, the plurality of first signal lines and the plurality of second signal lines being crossed to each other; a plurality of pixel units, each of which is located in an area surrounded by the first signal lines and the second signal lines and comprises a thin film transistor and a pixel electrode; and connecting assemblies arranged in parallel to the first signal lines, wherein the connecting assemblies comprise a plurality of first portions arranged in the layer in which the second signal lines are located and a plurality of second portions arranged in the layer in which the pixel electrode is located, the first signal lines, the second signal lines and the pixel electrodes being in different layers on the array substrate respectively, the first portions and the second portions in the connecting assemblies being arranged alternatively in a direction in which the first signal lines extend, the plurality of first portions being partly overlapped with the first signal lines respectively, the second portions being partly overlapped with adjacent first portions.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

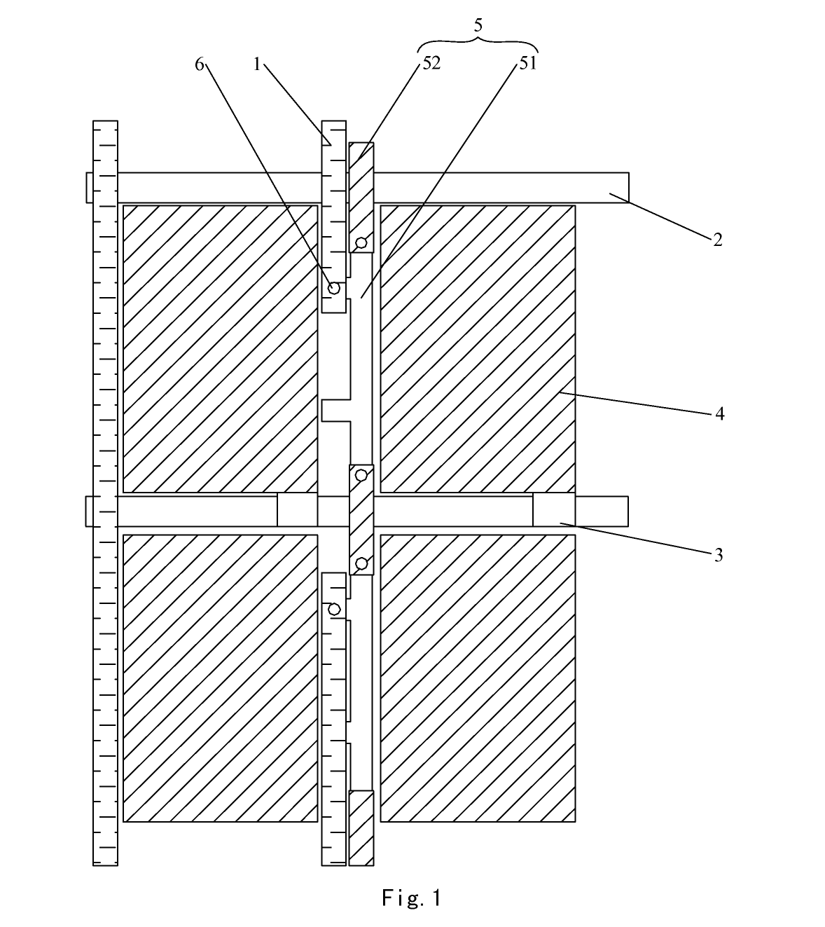

An embodiment of the present invention provides an array substrate, as illustrated in FIG. 1. The array substrate comprises:

a plurality of first signal lines 1 and a plurality of second signal lines 2 formed on the array substrate, the plurality of first signal lines 1 and the plurality of second signal lines 2 being crossed to each other; and a plurality of pixel units, each of which is surrounded by the first signal lines and the second signal lines and is not overlapped with the first signal lines and the second signal lines. Each of the plurality of pixel units comprises a thin film transistor 3 and a pixel electrode 4.

The array substrate further comprises:

connecting assemblies 5 arranged in parallel to the first signal lines 1, wherein the connecting assemblies 5 comprise a plurality of first portions 51 arranged in the layer in which the second signal lines 2 are located and a plurality of second portions 52 arranged in the layer in which the pixel electrodes 4 are located. The first signal lines 1, the second signal lines 2 and the pixel electrode 4 are located in different layers on the array substrate respectively, the first portions 51 and the second portions 52 in the connecting assemblies 5 being arranged alternatively in a direction in which the first signal lines 1 extend, the plurality of first portions 51 being partly overlapped with the first signal lines 1 respectively, the second portions 52 being partly overlapped with adjacent first portions 51.

As an example, the plurality of first signal lines 1 may be arranged substantially in parallel to each other. Also, the plurality of second signal lines 2 may be arranged substantially in parallel to each other. As an example, the first portions 51 and the first signal lines 1 are capable of being connected to each other by their overlapped parts. Also, the second portions 52 and adjacent first portions 51 are also capable of being connected to each other by the overlapped parts of the second portions and the adjacent first portions

In a technical solution of the present embodiment, the connecting assemblies 5 are arranged in parallel to the first signal lines 1 and comprise the first portions 51 arranged in the layer in which the second signal lines 2 are located and the second portions 52 arranged in the layer in which the pixel electrode 4 is located. Thus, the first portions 51 are partly overlapped with the first signal lines 1 and the second portions 52 are partly overlapped with the first portions 51. In this way, if one of the first signal lines is disconnected, it only needs to fuse the parts of the first portions 51 of the connecting assemblies overlapped with the first signal lines 1 on both sides of the disconnected location to the first signal lines 1 respectively and to fuse the overlapping parts of the first portions 51 and the second portions 52 of the connecting assemblies 5 respectively, in order to connect two ends of the disconnected first signal line 1. Such operational method is easy and convenient and thus can reduce the production period and can ensure the success rate of repairing.

As an example, after fusing the overlapping parts of the first portions 51 of the connecting assemblies 5 and the first signal lines 1 and fusing the first portions 51 to the second portions 52, the fusion points 6 as shown in FIG. 1 may be formed such that the first portions 51 are connected to the signal lines 1 and the first portions 51 are connected to the second portions 52.

As an example, the first portions 51 of the connecting assemblies 5 fused to the first signal lines 1 may be two first portions 51 on both sides of the disconnected location of the first signal line 1 and closest to the disconnected location.

As an example, the first portions 51 and the second portions 52 are arranged alternatively in the connecting assemblies 5, and generally the signal lines such as the first signal lines 1 and the second signal lines 2 are located in the lower layer above which the pixel electrodes 4 are located. Thus, the second portions 52 in the same layer as the pixel electrodes 4 traverse over the second signal lines 2. An insulation layer is provided between the second portions 52 and the second signal lines 2, for insulating the second portions 52 from the second signal lines 2.

In an example, in order to improve an aperture ratio of the array substrate, two adjacent first signal lines 1 are provided between adjacent two rows or columns of pixel units. The connecting assemblies 5 and the two adjacent first signal lines 1 are arranged in parallel, and the first portions 51 of the connecting assemblies 5 are partly overlapped with both of the two adjacent first signal lines 1.

As two adjacent first signal lines 1 are provided between adjacent two rows or columns of pixel units and the adjacent first signal lines 1 must be insulated from each other, there is a gap between the adjacent first signal lines 1. In consideration that the first portions 51 or the second portions 52 of the connecting assemblies 5 both are not arranged in the same layer as the first signal lines 1 and that the disconnecting both of two adjacent first signal lines 1 is very unlikely, the connecting assemblies 5 may be arranged between two adjacent first signal lines 1 to ensure the aperture ratio of the array substrate.

As the first portions 51 are arranged in the same layer as the second signal lines 2, in order to save the producing process, as an example, the first portions 51 and the second signal lines 2 are formed in one same patterning step (for example a single deposition). Similarly, as the second portions 52 are arranged in the same layer as the pixel electrode 4, as an example, the second portions 52 and the pixel electrode 4 are formed in one same patterning step.

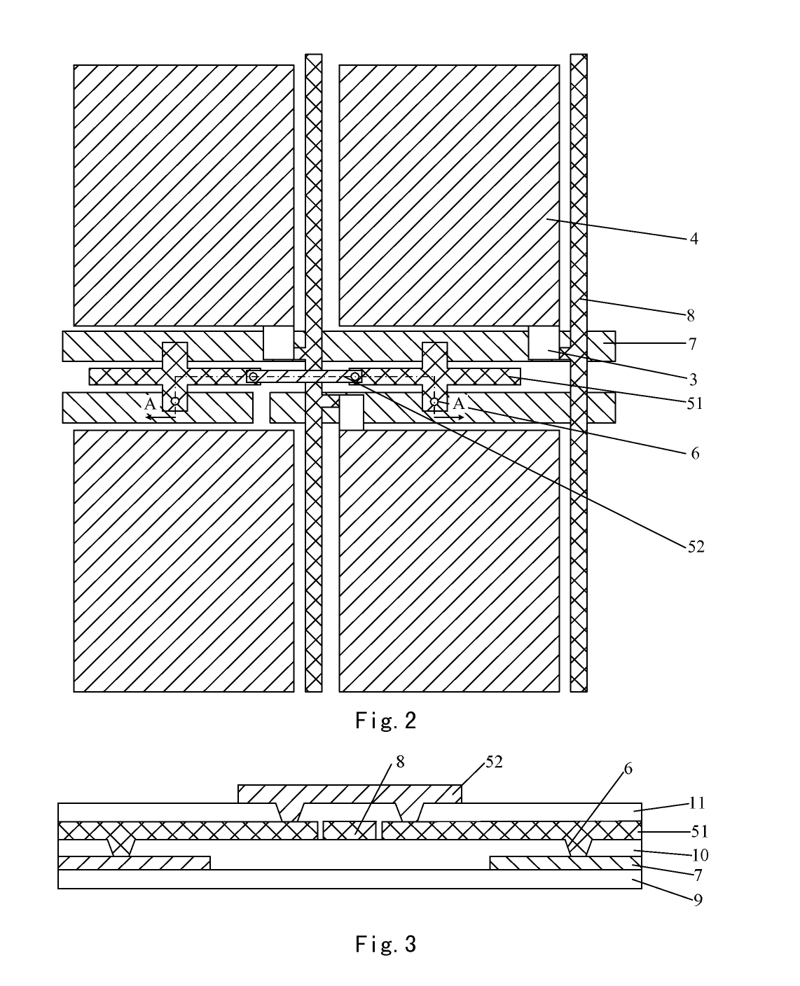

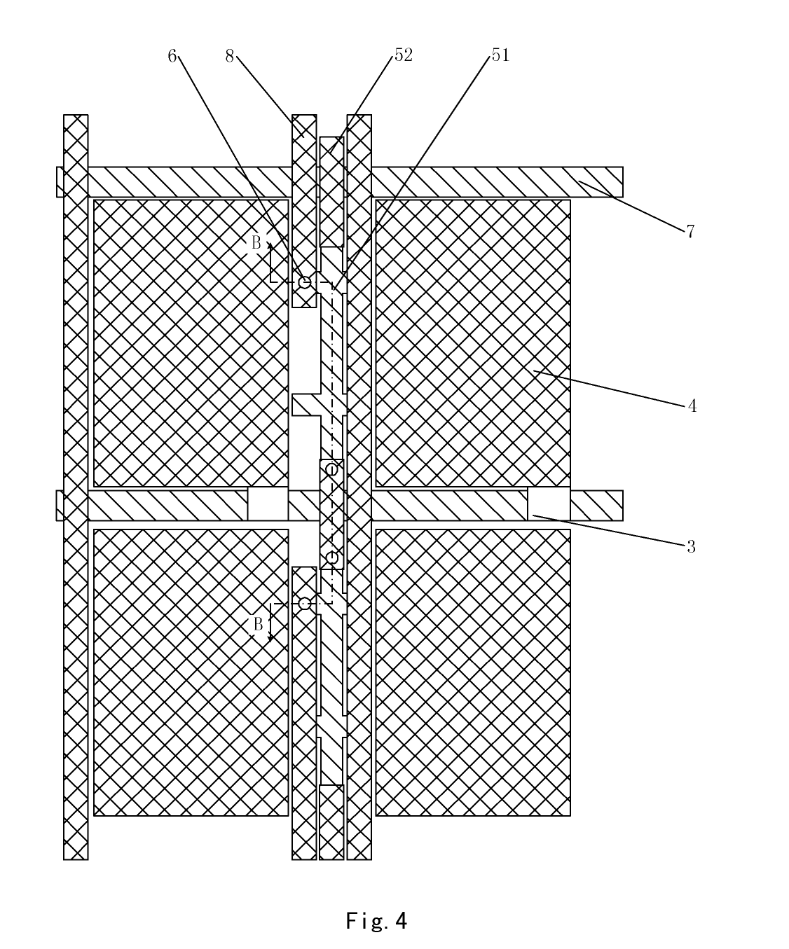

In an embodiment of the present invention, as illustrated in FIG. 2, the first signal lines 1 may be gate lines 7, in this example, the second signal lines 2 are data lines 8. Or as illustrated in FIG. 4, the first signal lines 1 may be data lines 8 and the second signal lines 2 are gate lines 7.

An exemplary embodiment of the present invention will be further explained with reference to the case that the first signal lines 1 are gate lines 7 and the second signal lines 2 are data lines 8.

As illustrated in FIG. 2, two adjacent gate lines 7 are provided between adjacent two rows of pixel units and the connecting assemblies 5 are provided between two adjacent gate lines 7. If one gate line of the gate lines 7 is disconnected, the first portions 51 and the second portion 52 of the connecting assemblies 5 around the disconnected gate line 7 may be fused and the first portions 51 of the connecting assemblies 5 are respectively fused to the disconnected gate line 7 on both sides of the disconnected location, in order to repair the disconnected gate line 7.

As illustrated in FIG. 3, which is a sectional view taken along line A-A of FIG. 2, the gate lines 7 are located the lowest layer of the whole stack, i.e., the gate lines 7 are arranged directly on a substrate base 9. A first insulation layer 10 is formed on the gate lines 7. As the gate lines 7 are typically arranged in the same layer as the gate electrode and are formed in one same patterning step (for example a single deposition), the first insulation layer 10 is also called as a gate insulation layer, for example, it may be made from insulation materials, such as silicon oxide, silicon nitride, hafnium oxide, or resin. It can insulate the gate electrodes and gate lines from other structural parts and protect the gate electrodes and gate lines 7 from being destroyed in the subsequent processes for forming the respective layers.

An active layer of the thin film transistors 3 of the pixel units, data lines 8, source electrodes, drain electrodes of the thin film transistors 3 of the pixel units in the same layer as the data lines 8, and the first portions 51 of the connecting assemblies 5 are formed in sequence on the first insulation layer 10. As described above, all of the data lines 8, the source electrodes, the drain electrodes and the first portions 51 are formed in one same pattering step.

Then, a second insulation layer 11 is formed on the data lines 8, the source electrodes, the drain electrodes and the first portions 51 that are located in the same layer. The second insulation layer 11 is typically called as a passivation layer, for example, it may be made from insulation materials, such as silicon oxide, silicon nitride, hafnium oxide, or resin. The passivation layer can not only improve the tolerance of the display apparatus for the rough environments, but also can help to improve the photo parameter performance of the thin film transistor units 3.

At last, the pixel electrodes 4 and the second portions 52 of the connecting assemblies 5 in the same layer as the pixel electrode 4 are formed on the second insulation layer 11. Similarly, the second portions 52 and the pixel electrodes 4 are formed in one same patterning step. For example, the second portions 52 and the pixel electrodes 4 may be formed from transparent conductive materials such as Indium tin oxide or Indium zinc oxide.

As illustrated in FIGS. 2-3, if the gate lines 7 on the array substrate are disconnected, fusing operations may be performed at multiple times at the overlapping parts of the first portions 51 and gate lines 7, and the overlapping parts of the first portions 51 and the second portions 52 respectively, so as to form conductive fusion points 6 to repair the disconnected gate lines 7. And the repairing method is easy and convenient and will not affect the aperture ratio of the array substrate. As an example, as illustrated in FIG. 3, the fusion points 6 of the first portions 51 of the connecting assemblies 5 with the first signal lines 1(gate lines 7) may be arranged at the parts of the first portions 51 overlapped with the first signal lines 1 (gate lines 7).

Similarly, another embodiment of the present invention will be further explained with reference to the case that the first signal lines 1 are data lines 8 and the second signal lines 2 are gate lines 7.

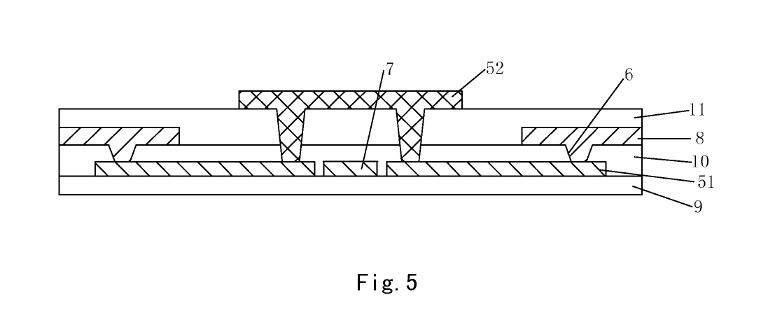

As an example, as illustrated in FIG. 4, two adjacent data lines 8 are located between adjacent two columns of pixel units and the connecting assemblies 5 are arranged between two adjacent data lines 8. Then, with reference to FIG. 4 and FIG. 5 which is a cross sectional view taken along line B-B, if the data lines 8 are disconnected, fusing operations may be performed at multiple times at the overlapping parts of the first portions 51 and data lines 8 and the overlapping parts of the first portions 51 and the second portions 52 respectively, so as to form conductive fusion points 6 to repair the disconnected data lines 8. The further explanations will be omitted herein.

It should be noted that the thin film transistors 3 as described in the above embodiment is bottom gate type thin film transistors, however, top gate type thin film transistors may also be used herein. In the latter case, the data lines 8 are located in a layer below the gate lines 7.

An embodiment of the present invention further provides a display apparatus comprising the array substrate as described in any of the above examples. As an example, the display apparatus may be any products or components having display function, such as a liquid crystal panel, an electronic paper, an OLED panel, a liquid crystal TV, a liquid crystal display, a digital photo frame, a cell phone or a tablet computer.

An embodiment of the present invention further provides a method for repairing the array substrate described in any of the above embodiments, comprising:

if one of the first signal lines 1 is disconnected, connecting the first portions 51 of the connecting assemblies 5 on either both sides of the disconnected location of the one of the first signal lines 1 to the parts of the first signal lines 1 overlapped with the first portions 51 respectively, and connecting the first portions 51 of the connecting assemblies 5 connected to the one of the first signal lines 1 to the second portions 52 thereof overlapped with the first portions 51 respectively.

As an example, the connections of the parts of the first portions 51 of the connecting assemblies 5 overlapped with the first signal lines 1 to the first signal lines 1 and the connections of the first portions 51 of the connecting assemblies 5 connected to the first signal lines 1 to the second portion 52 overlapped with the first portions 51 can be performed by fusion respectively.

As an example, in fusing operations, a laser may not only form a via communicating the first portions 51 with the first signal lines 1 at the overlapping parts of the first portions 51 and the first signal lines 1, but also may melt the first portions 51 by an instantaneous high temperature to fill the via with the melted first portions 51, so as to achieve the electrical connection between the first portions 51 and the first signal lines 1.

Similarly, as an example, the laser may also fuse the first portions 51 and the second portions 52 at their overlapping parts to achieve the electrical connection between the first portions 51 and the second portions 52.

It should be noted that, in practice, the fusing operations may need to be performed at several times until the disconnected first signal line 1 has been repaired. For example, in the structure as shown in FIG. 1, it needs four fusing operations, that is, repairing the disconnected line will not be completed until two ends of the second portion 52 closest to the disconnected location have been fused to the corresponding first portions 51 respectively and the first portions 51 fused to the second portion 52 have been fused to the parts of the first signal lines 1 overlapped with the first portions 51.

As an example, the first signal lines 1 may be gate lines 7 or data lines 8. Thus, if one of the gate lines 7 is disconnected, it will connect the first portions 51 of the connecting assemblies 5 to the parts of the gate lines 7 overlapped with the first portions 51 respectively, and connect the first portions 51 to the second portion 52 of the connecting assemblies 5 overlapped with the first portions 51 respectively. Or, if one of the data lines 8 is disconnected, it will connect the first portions 51 of the connecting assemblies 5 to the parts of the data lines 8 overlapped with the first portions 51 respectively, and connect the first portions 51 to the second portion 52 of the connecting assemblies 5 overlapped with the first portions 51 respectively.

Although several exemplary embodiments have been shown and described, the present invention is not limited to those and it would be appreciated by those skilled in the art that various changes or modifications may be made in these embodiments without departing from the principles and spirit of the disclosure, which should fall within the scope of the present invention. The scope of the invention is defined in the claims and their equivalents.

What is claimed is:

1. An array substrate, comprising:
a plurality of first signal lines and a plurality of second signal lines formed on the array substrate, the plurality of first signal lines and the plurality of second signal lines being crossed to each other;
a plurality of pixel units, each of which is located in one of areas surrounded by the first signal lines and the second signal lines and comprises a thin film transistor and a pixel electrode; and
connecting assemblies arranged in parallel to the first signal lines,
wherein the connecting assemblies comprise a plurality of first portions arranged in the layer in which the second signal lines are located and a plurality of second portions arranged in the layer in which the pixel electrodes are located, and the first signal lines, the second signal lines and the pixel electrodes being in different layers on the array substrate respectively, the first portions and the second portions in the connecting assemblies being arranged alternatively in a direction in which the first signal lines extend, the plurality of first portions being partly overlapped with the first signal lines respectively, and the second portions being partly overlapped with adjacent first portions.

2. The array substrate according to claim 1, wherein the plurality of first signal lines are arranged substantially in parallel to each other and the plurality of second signal lines are arranged substantially in parallel to each other.

3. The array substrate according to claim 1, wherein the first portions and the first signal lines are capable of being connected to each other by their overlapped parts and the second portions and adjacent first portions are also capable of being connected to each other by overlapped parts of the second portions and the adjacent first portions.

4. The array substrate according to claim 1, wherein the first portions are provided with fusion points for fusing the first portions to the first signal lines at the parts of the first portions overlapped with the first signal lines, and wherein the second portions are provided with fusion points for fusing the second portions to adjacent first portions at the parts of the second portions overlapped with the adjacent first portions.

5. The array substrate according to claim 1, wherein the first signal lines are provided with fusion points for fusing the first signal lines to the first portions at the parts of the first signal lines overlapped with the first portions, and wherein the second portions are provided with fusion points for fusing the second portions to adjacent first portions at the parts of the second portions overlapped with the adjacent first portions.

6. The array substrate according to claim 1, wherein the second portions traverse over the second signal lines and an insulation layer is provided between the second portions and the second signal lines.

7. The array substrate according to claim 6, wherein two adjacent first signal lines are provided between two adjacent rows or columns of pixel units, the connecting assemblies and the two adjacent first signal lines being arranged in parallel to each other, and the first portions of the connecting assemblies being partly overlapped with both of the two adjacent first signal lines.

8. The array substrate according to claim 7, wherein the connecting assemblies are provided between the two adjacent first signal lines.

9. The array substrate according to claim 1, wherein the first portions and the second signal lines are formed at one same patterning step and wherein the second portions and the pixel electrode are formed at another same patterning step.

10. The array substrate according to claim 9, wherein the first signal lines are gate lines and the second signal lines are data lines.

11. The array substrate according to claim 9, wherein the first signal lines are data lines and the second signal lines are gate lines.

12. A display apparatus, comprising the array substrate according to claim 1.

13. A method for repairing the array substrate according to claim 1, comprising:
if one of the first signal lines is disconnected, connecting the first portions of the connecting assemblies on both sides of the disconnected location of the one of the first signal lines to the parts of the first signal lines overlapped with the first portions respectively, and connecting the first portions of the connecting assemblies connected to the one of the first signal lines to the parts of the second portion of the connecting assemblies overlapped with the first portions respectively.

14. The method according to claim 13, wherein connecting the first portions of the connecting assemblies to the parts of the first signal lines overlapped with the first portions and connecting the first portions of the connecting assemblies to the parts of the second portion of the connecting assemblies overlapped with the first portions are performed by fusion.

15. The method according to claim 14, wherein the first signal lines are gate lines.

16. The method according to claim 14, wherein the first signal lines are data lines.
